(19) United States
(12) Patent Application Publication
(10) Pub. No.: US 2008/0241618 A1
(43) Pub. Date: Oct. 2, 2008

(54) FUEL CELL

(76) Inventors: Yuusuke Sato, Tokyo (JP); Hiroaki Hirazawa, Inagi-shi (JP); Masato Akita, Yokohama-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/054,889

(22) Filed: Mar. 25, 2008

(30) Foreign Application Priority Data
Mar. 28, 2007 (JP) 2007-086019

(51) Int. Cl. H01M 8/04

(52) U.S. Cl. 429/22; 429/35

(57) ABSTRACT

A fuel cell is provided with an assembly including an electrolytic membrane and anode and cathode electrodes on both sides of the membrane, a unit providing a path for supplying liquid fuel to the anode side of the membrane, a unit providing a path for supplying air to the cathode electrode side of the membrane, a unit providing a path for discharging gas from the anode electrode side of the membrane, and stacking members stacked in a state of sealing each other on an outer surface of the anode electrode. In this cell, the anode electrode and the stacking members configure a stacking structure, the liquid fuel supply path includes at least one through-hole passing through the stacking structure, and the gas discharge path includes at least one through-hole passing through the stacking structure independently of the at least one through-hole of the liquid fuel supply path.

### CROSS-REFERENCE TO RELATED APPLICATIONS

This application is based upon and claims the benefit of priority from prior Japanese Patent Application No. 2007-086019, filed Mar. 28, 2007, the entire contents of which are incorporated herein by reference.

### BACKGROUND OF THE INVENTION

1. Field of the Invention

This invention relates to a fuel cell.

2. Description of the Related Art

A fuel cell configured as described in the followings has been known. Such a conventional fuel cell comprises an membrane-electrode assembly configured to include an electrolytic membrane and anode and cathode electrodes which are disposed on both sides of the electrolytic membrane; a liquid fuel supply unit configured to provide a liquid fuel supply path which supplies liquid fuel to the anode electrode side of the electrolytic membrane in the membrane-electrode assembly; an air supply unit configured to provide an air supply path which supplies air to the cathode electrode side of the electrolytic membrane in the membrane-electrode assembly; and a liquid discharge unit configured to provide a liquid discharge path which discharges liquid generated on the cathode electrode side of the electrolytic membrane in the membrane-electrode assembly, and uses, for example a mixture of methanol (CH₃OH) and water (H₂O) as the liquid fuel.

In this conventional fuel cell, the mixture of methanol and water as the liquid fuel which are supplied from a liquid fuel tank to the anode electrode side of the electrolytic membrane in the membrane-electrode assembly through the liquid fuel supply path are caused to react in the following manner by a catalyst provided on the anode electrode side of the electrolytic membrane to release carbon dioxide (CO₂), hydrogen ions (H⁺), and electrons (e⁻).

CH₃OH+H₂O→CO₂+6H⁺+6e⁻

The electrons (e⁻) move from the anode electrode toward the cathode electrode through an electric wire connecting the anode electrode and the cathode electrode. The hydrogen ions (H⁺) permeate the electrolytic membrane from the anode electrode side to the cathode electrode side, and then the hydrogen ions (H⁺) are caused to react with oxygen (O₂) in the air supplied to the cathode electrode side of the electrolytic membrane of the membrane-electrode assembly through the air supply path, by a catalyst provided on the cathode electrode side of the electrolytic membrane in the following manner to become water (H₂O).

3/2×O₂+6H⁺+6e⁻→3H₂O

Water generated on the cathode electrode side of the electrolytic membrane in the membrane-electrode assembly is discharged to the outside of the membrane-electrode assembly through the liquid discharge path, and thereafter is returned to the liquid fuel tank. A fuel tank for replenishment is connected to the liquid fuel tank, and the replenishment fuel tank stores methanol which is higher in concentration than that in the liquid fuel in the liquid fuel tank. And, when the methanol concentration in the liquid fuel in the liquid fuel tank becomes equal to or lower than a predetermined value, a predetermined amount of highly-concentrated methanol is replenished from the replenishment fuel tank to the liquid fuel tank to make the methanol concentration of the liquid fuel in the liquid fuel tank return to a predetermined value.

In such a conventional fuel cell, carbon dioxide (CO₂) generated on the anode electrode side of the electrolytic membrane in the membrane-electrode assembly, together with liquid fuel unreacted on the anode electrode side of the electrolytic membrane in the membrane-electrode assembly, is discharged to the outside of the membrane-electrode assembly through a liquid fuel return path. An outer end of the liquid fuel return path is connected to a gas-liquid separator, and the unreacted liquid fuel, the carbon dioxide (CO₂), and organic gas evaporated from the unreacted liquid fuel are separated from one another by the gas-liquid separator.

The separated and unreacted liquid fuel is mixed with fresh liquid fuel, and the mixed liquid fuel is supplied again to the anode electrode side of the electrolytic membrane in the membrane-electrode assembly through the liquid fuel supply path. The separated carbon dioxide (CO₂) and the separated organic gas are discharged to an outer space through an organic matter removing device.

JP-A 2002-175817 (KOKAI) discloses another conventional fuel cell. This conventional fuel cell comprises: a liquid fuel supply path structured by a plurality of slender grooves formed in an inner surface of an anode electrode, the inner surface facing an electrolytic membrane, so as to extend in parallel with each other from one end of the inner surface to the vicinity of the other end thereof positioned opposite to the one end; and a gas discharge path structured by a plurality of slender grooves formed between the slender grooves of the liquid fuel supply path in the inner surface so as to extend in parallel with each other from the other end of the inner surface to the vicinity of the one end thereof.

Further, JP-A 2001-110433 (KOKAI) discloses a separator for a fuel cell. This conventional separator comprises a plurality of plates each of which includes a plurality of through-holes, each through-hole being slender in its plain shape, and provides a plurality of fuel gas flow holes by stacking these plates so as to overlap a part of each slender through-hole of each plate with each other.

In the conventional fuel cell which is described above but has not been described in documents relating patent, the gas-liquid separator is separated from the membrane-electrode assembly so that the overall size of the fuel cell is large to make a choice of installation of the fuel cell being limited and to make a manufacturing cost of the fuel cell being high. Besides, since a circulation distance of the liquid fuel which circulates in the anode electrode side of the electrolytic membrane in the membrane-electrode assembly is long, a pressure loss of the liquid fuel is large. That is, an operation efficiency of the fuel cell is reduced.

In the conventional fuel cell described in JP-A 2002-175817 (KOKAI), a fuel penetration plate for separating gas and liquid from each other is provided in each slender groove of the liquid fuel supply path so that a structure of the fuel cell is complex. And further, an external liquid fuel supply piping for supplying liquid fuel to the liquid fuel supply path structured by the slender grooves whose outer ends open at the one end of the inner surface of the anode electrode and an external gas discharge piping for discharging gas from the gas discharge path structured by the slender grooves whose outer ends open at the other end of the inner surface of the anode electrode increase complexity of the outer shape of this conventional fuel cell and an overall size thereof.

JP-A 2001-110433 (KOKAI) which describes the separator for a fuel cell shows only a structure for simply forming the fuel gas flow holes for the separator.

### BRIEF SUMMARY OF THE INVENTION

A fuel cell according to one aspect of this invention comprises: a membrane-electrode assembly including an electrolytic membrane and anode and cathode electrodes disposed on both sides of the membrane, the anode electrode having an outer surface and an inner surface opposing to the outer surface and facing the membrane; a liquid fuel supply unit configured to provide a liquid fuel supply path supplying liquid fuel to the anode electrode side of the membrane in the assembly; an air supply unit configured to provide an air supply path supplying air to the cathode electrode side of the membrane in the assembly; a gas discharge unit configured to provide a gas discharge path discharging gas from the anode electrode side of the membrane in the assembly; and a plurality of stacking members stacked in a state of sealing each other on the outer surface of the anode electrode. In this fuel cell, the anode electrode and the stacking members configure a stacking structure, the liquid fuel supply path includes at least one through-hole passing through the stacking structure, and the gas discharge path includes at least one through-hole passing through the stacking structure independently of the at least one through-hole of the liquid fuel supply path.

### BRIEF DESCRIPTION OF THE SEVERAL VIEWS OF THE DRAWINGS

FIG. 1 is a longitudinal sectional view schematically showing an overall configuration of a fuel cell according to a first embodiment of this invention;

FIG. 2A is a schematic view of an inner surface of an anode electrode in the fuel cell according to the first embodiment in FIG. 1;

FIG. 2B is a schematic view of an inner surface of a first stacking member to be stacked on an outer surface of the anode electrode in FIG. 2A;

FIG. 3 is a schematic view of an inner surface of a second stacking member to be stacked on an outer surface of the first stacking member in FIG. 2B;

FIG. 4A is a schematic view of the inner surface of the anode electrode while the anode electrode, the first stacking member, and the second stacking member in FIGS. 2A, 2B, and 3 are stacked one by one in this order;

FIG. 4B is a schematic longitudinal sectional view taken along a line IVB-IVB in FIG. 4A;

FIG. 4C is a schematic longitudinal sectional view taken along a line IVC-IVC in FIG. 4A;

FIG. 5 is an exploded perspective view of a main part of a first modification of the fuel cell according to the first embodiment in FIG. 1;

FIG. 6 is a schematic longitudinal sectional view of a second modification of the fuel cell according to the first embodiment in FIG. 1;

FIG. 7A is a longitudinal sectional view schematically showing an overall configuration of a fuel cell according to a second embodiment of this invention;

FIG. 7B is a schematic longitudinal sectional view of a specific part of the configuration of the fuel cell according to the second embodiment in FIG. 7A;

FIG. 8A is a schematic view of an inner surface of an anode electrode in the fuel cell according to the second embodiment in FIG. 7A;

FIG. 8B is a schematic view of an inner surface of a first stacking member to be stacked on an outer surface of the anode electrode in FIG. 8A;

FIG. 9A is a schematic view of an inner surface of a second stacking member to be stacked on an outer surface of the first stacking member in FIG. 8B;

FIG. 9B is a schematic view of an inner surface of a third stacking member to be stacked on an outer surface of the second stacking member in FIG. 9A;

FIG. 10 is a schematic view of an inner surface of a fourth stacking member to be stacked on an outer surface of the third stacking member in FIG. 9B;

FIG. 11A is a schematic view of the inner surface of the anode electrode while the anode electrode, the first stacking member, the second stacking member, the third stacking member, and the fourth stacking member in FIGS. 8A, 8B, 9A, 9B, and 10 are stacked one by one in this order;

FIG. 11B is a schematic longitudinal sectional view taken along a line XIB-XIB in FIG. 11A; and

FIG. 11C is a schematic longitudinal sectional view taken along a line XIC-XIC in FIG. 11A.

### DETAILED DESCRIPTION OF THE INVENTION

### First Embodiment

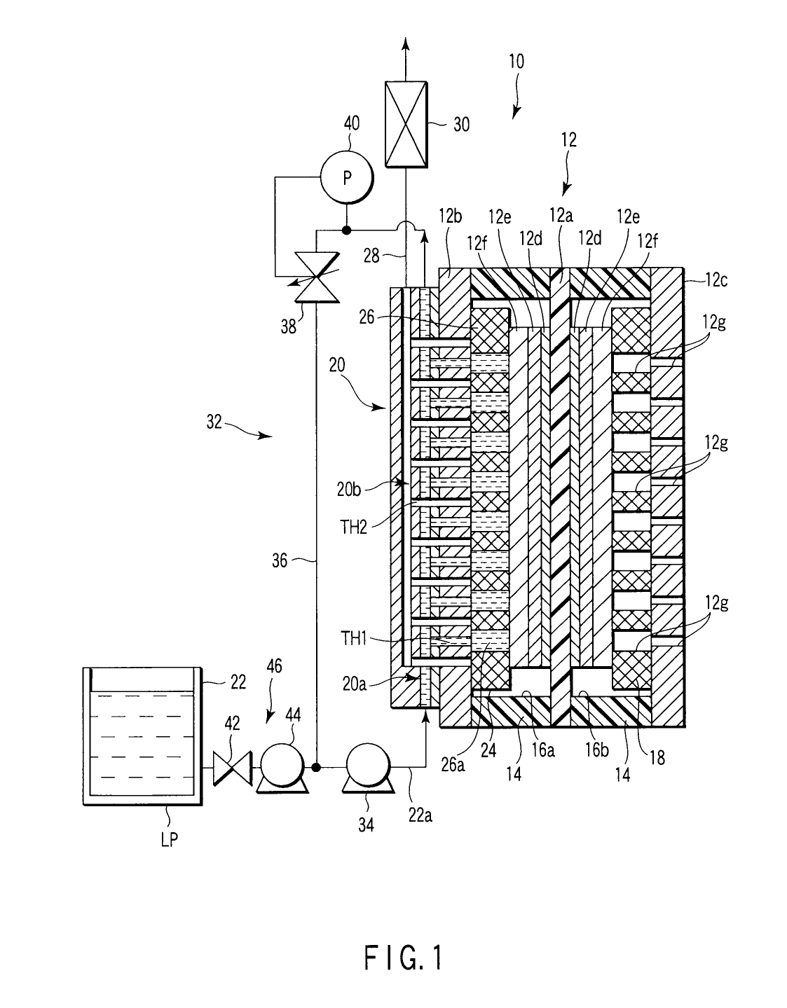

In FIG. 1, a longitudinal sectional view of a fuel cell 10 according to a first embodiment of the present invention is schematically shown.

The fuel cell 10 is provided with a membrane-electrode assembly 12 including an electrolytic membrane 12a, and anode and cathode electrodes 12b and 12c which are disposed on both sides of the electrolytic membrane 12a. In the membrane-electrode assembly 12, a peripheral edge of the anode electrode 12b and that of the cathode electrode 12c are respectively sealed with peripheral edges of both surfaces of the electrolytic membrane 12a by sealing members 14 to provide an anode chamber 16a between the electrolytic membrane 12a and the anode electrode 12b and a cathode chamber 16b between the electrolytic membrane 12a and the cathode electrode 12c.

The electrolytic membrane 12a includes catalyst layers 12d on its both side surfaces in the anode and cathode chambers 16a and 16b, and further an electrically conductive microporous layer 12e such as a carbon porous body and an electrically conductive gas diffusion layer 12f such as a carbon paper are stacked on each of the catalyst layers 12d.

A plurality of through-holes is formed in the cathode electrode 12c, and the through-holes communicate the cathode chamber 16b with an outside space. An electrically conductive interposition member 18 is interposed between the gas diffusion layer 12f and the cathode electrode 12c in the cathode chamber 16b. And, a plurality of through-holes is also formed in the interposition member 18 to correspond to the through-holes of the cathode electrode 12c, and the through-holes in the interposition member 18 extend between the cathode electrode 12c and the gas diffusion layer 12f. The through-holes of the cathode electrode 12c and the through-holes of the interposition member 18 configure air supply paths 12g which supply air from the outside space to the cathode electrode side of the electrolytic membrane 12a in the membrane-electrode assembly 12.

A plurality of stacking members stacked in a state of sealing each other is fixed on an outer surface of the anode electrode 12b, and the anode electrode 12b and the stacking members configure a stacking structure 20.

A liquid fuel supply path 20a is formed in the stacking structure 20. The supply path 20a includes at least one through-hole TH1 communicating the anode chamber 16a with the outside space and used to supply liquid fuel to the anode electrode side of the electrolytic membrane 12a in the membrane-electrode assembly 12. A gas discharge path 20b is further formed in the stacking structure 20. The gas discharge path 20b includes at least one through-hole TH2 further communicating the anode chamber 16a with the outside space and used to discharge gas from the anode electrode side of the electrolytic membrane 12a in the membrane-electrode assembly 12.

A liquid fuel supply pipe 22a extending from a liquid fuel tank 22 is connected to an outer end of the at least one through-hole TH1 of the liquid fuel supply path 20a in the stacking structure 20. In this embodiment, the liquid fuel tank 22 holds methanol which is a kind of hydrocarbon and which is relatively high in concentration, as a liquid fuel LP. The methanol may be diluted with water.

Therefore, in this embodiment, the liquid fuel supply pipe 22a further configures the liquid fuel supply path 20a which supplies the liquid fuel LP to the anode electrode side of the electrolytic membrane 12a in the membrane-electrode assembly 12.

The liquid fuel LP (in this embodiment, methanol (CH₃OH) which is relatively high in concentration) supplied from the liquid fuel tank 22 to the anode electrode side of the electrolytic membrane 12a in the membrane-electrode assembly 12 through the liquid fuel supply path 20a is caused to release carbon dioxide (CO₂), hydrogen ions (H⁺), and electrons (e⁻) by the catalyst layer 12d on the anode electrode side of the electrolytic membrane 12a as shown in the following.

CH₃OH+H₂O→CO₂+6H⁺+6e⁻

The electrons (e⁻) move from the anode electrode 12b toward the cathode electrode 12c through an electric wire (not shown) connecting the anode electrode 12b and the cathode electrode 12c. The hydrogen ions (H⁺) permeate the electrolytic membrane 12a from the anode electrode side to the cathode electrode side, so that the hydrogen ions (H⁺) react with oxygen (O₂) in the air supplied to the cathode electrode side of the electrolytic membrane 12a of the membrane-electrode assembly 12 through the air supply paths 12g, by the catalyst layer 12d provided on the cathode electrode side of the electrolytic membrane 12a in the following manner to become water (H₂O).

3/2×O₂+6H⁺+6e⁻→3H₂O

The water (H₂O) generated as described above on the cathode electrode side of the electrolytic membrane 12a in the membrane-electrode assembly 12 is discharged from the air supply paths 12g to the outside space in a liquid or evaporated state.

In the fuel cell 10, unless the gas (in this embodiment, carbon dioxide (CO₂)) generated as described above from the liquid fuel LP on the anode electrode side of the electrolytic membrane 12a in the membrane-electrode assembly 12 is discharged to the outside space, the gas prevents the liquid fuel LP (in this embodiment, methanol (CH₃OH) which is relatively high in concentration) supplied to the anode electrode side of the electrolytic membrane 12a in the membrane-electrode assembly 12 through the liquid fuel supply path 20a, from coming in contact with the catalyst layer 12d on the anode electrode side of the electrolytic membrane 12a, and an electric power generation in the fuel cell 10 can be impossible.

Therefore, the fuel cell 10 is provided with the gas discharge path 20b for releasing the gas (in this embodiment, carbon dioxide (CO₂)) generated as described above from the liquid fuel LP on the anode electrode side of the electrolytic membrane 12a in the membrane-electrode assembly 12.

The fuel cell 10 is further provided with a gas-liquid separating structure 24 between the electrolytic membrane 12a and the anode electrode 12b in the membrane-electrode assembly 12. The gas-liquid separating structure 24 is configured to separate the liquid fuel supplied to the anode electrode side of the electrolytic membrane 12a in the membrane-electrode assembly 12 through the liquid fuel supply path 20a and the gas generated from the liquid fuel on the anode electrode side of the electrolytic membrane 12a from each other, and to lead the separated gas to the gas discharge path 20b.

The gas-liquid separating structure 24 includes an electrically conductive minute pore member 26 interposed between the gas diffusion layer 12f and the anode electrode 12b in the anode chamber 16a. The minute pore member 26 includes many minute pores, and can be, for example, a so-called porous member. The minute pore member 26, however, may have such a structure in which fibers are woven or entwined to provide many minute pores.

The minute pore member 26 includes a plurality of through-holes 26a extending toward the electrolytic membrane 12a from a position corresponding to an outlet port of the at least one through-hole TH1 of the liquid fuel supply path 20a in the inner surface of the anode electrode 12b, and, therefore, in this embodiment, the through-holes 26a of the minute pore member 26 also configures the liquid fuel supply path 20a for supplying the liquid fuel LP to the anode electrode side of the electrolytic membrane 12a in the membrane-electrode assembly 12.

In the minute pore member 26, a part of the minute pore member 26 excepting the through-holes 26a configures many fine pores each of which is smaller than each through-hole 26a and which communicate the through-holes 26a with an outlet port of the at least one through-hole TH2 of the gas discharge passage 20b in the inner surface of the anode electrode 12b.

Specifically, it is necessary for the minute pore member 26 to have at least either one of hydrophobic nature and repellency. In this embodiment, the minute pore member 26 is formed of electrically conductive hydrophobic material, for example, carbon, and is subjected to a water repellent finish. An inner end of the at least one through-hole TH2 of the gas discharge path 20b in the inner surface of the anode electrode 12b faces the part of the minute pore member 26 in which the through-holes 26a corresponding to the at least one through-hole TH1 of the liquid fuel supply path 20a are not formed.

An outer end of the at least one through-hole TH2 of the gas discharge path 20b in the stacking structure 20 is connected to one end portion of a gas discharging pipe 28 which is independent of the liquid fuel supply pipe 22a of the liquid fuel supply path 20a. The other end portion of the gas discharge pipe 28 is opened to the outside space through a volatile organic compounds removing filter 30.

Therefore, in this embodiment, many minute pores of the minute pore member 26 and the gas discharge pipe 28 also configure the gas discharge path 20b discharging the gas from the anode electrode side of the electrolytic membrane 12a in the membrane-electrode assembly 12.

Since the minute pore member 26 which is one end portion of the gas discharge path 20b has at least either one of hydrophobic nature and repellency, the minute pore member 26 prevents the liquid fuel in the through-holes 26a of the minute pore member 26 which is a part of the liquid fuel supply path 20a, from entering into the many minute pores of the minute pore member 26. However, the gas can permeate the many minute pores. This means that the minute pore member 26 which is the one end portion of the gas discharge path 20b is configured to separate the gas and the liquid fuel.

The fuel cell 10 according to this embodiment is provided with a gas-liquid separation accelerating structure 32. The gas-liquid separation accelerating structure 32 makes the pressure of the liquid fuel LP in the liquid fuel supply path 20a on the anode electrode side of the electrolytic membrane 12a in the membrane-electrode assembly 12 being higher than that of the gas (in this embodiment, carbon dioxide (CO₂)) in the one end portion of the gas discharge path 20b. As a result, the gas (in this embodiment, carbon dioxide (CO₂)) which is generated from the liquid fuel LP on the anode electrode side of the electrolytic membrane 12a in the membrane-electrode assembly 12 and which does not pass through the electrolytic membrane 12a is discharged from the liquid fuel supply path 20a on the anode electrode side of the electrolytic membrane 12a in the membrane-electrode assembly 12 to the one end portion of the gas discharge path 20b.

In this embodiment, a liquid fuel pressurizing unit 34 is interposed in the liquid fuel supply path 20a. The liquid fuel pressurizing unit 34 can comprise, for example, a pressurizing pump. Besides, a liquid fuel return path 36 is further provided in this embodiment. One end portion of the liquid fuel return path 36 is connected to the at least one through-hole TH1 of the liquid fuel supply path 20a in an outermost stacking member in the stacking structure 20, and the other end portion thereof is connected to the liquid fuel supply path 20a between the liquid fuel tank 22 and the liquid fuel pressurizing unit 34 in the outside of the membrane-electrode assembly 12 and stacking structure 20.

The liquid fuel return path 36 returns the liquid fuel LP unreacted on the anode electrode side of the membrane electrode 12a in the membrane-electrode assembly 12 to the liquid fuel supply path 20. The liquid fuel circulating here is generally about several moles.

A back-pressure valve 38 is interposed in the liquid fuel return path 36 and a pressure gauge 40 is further interposed in the liquid fuel return path 36 between the back-pressure valve 38 and the one end portion of the return path 36 in the stacking structure 20. The pressure gauge 40 is configured to control opening and closing operations of the back-pressure valve 38. Specifically, when the pressure gauge 40 detects a pressure equal to or more than a predetermined value, the pressure gauge 40 operates to open the back-pressure valve 38. And, while the pressure gauge 40 detects a pressure less than the predetermined value, the pressure gauge 40 closes the back-pressure valve 38.

An on-off valve 42 and a pressurizing pump 44 are further interposed in the liquid fuel supply path 20a between the other end portion of the liquid fuel return path 36 and the liquid fuel tank 22.

In the fuel cell 10 according to the first embodiment and configured as described above, the pressure of the liquid fuel LP contained in a portion of the liquid fuel supply path 20a from the liquid fuel pressurizing unit 34 to the anode electrode side of the electrolytic membrane 12a in the membrane-electrode assembly 12 and in a portion of the liquid fuel return path 36 from the stacking structure 20 to the back pressure valve 38, is always kept at a predetermined value by the pressure gauge 40. That is, the pressure of the liquid fuel LP in the liquid fuel supply path 20a on the anode electrode side of the electrolytic membrane 12a in the membrane-electrode assembly 12 is always increased by a predetermined value more than that of the gas (in this embodiment, carbon dioxide (CO₂)) in the minute pore member 26 which is the one end portion of the gas discharge path 20b connected to the liquid fuel supply path 20a on the anode electrode side of the electrolytic membrane 12a.

This means that, in this embodiment, a combination of the liquid fuel pressurizing unit 34 interposed in the liquid fuel supply path 20a and the liquid fuel return path 36 with the back-pressure valve 38 and pressure gauge 40 configures the gas-liquid separation accelerating structure 32.

Such a gas-liquid separation accelerating structure 32 as described above makes it easier to discharge the gas (in this embodiment, carbon dioxide (CO₂)) generated on the anode electrode side of the electrolytic membrane 12a in the membrane-electrode assembly 12, into the minute pore member 26 which is the one end portion of the gas discharge path 20b connected to the liquid fuel supply path 20a on the anode electrode side of the electrolytic membrane 12a than to keep the gas being contained in the liquid fuel LP on the anode electrode side of the electrolytic membrane 12a in the membrane-electrode assembly 12. This acceleration is preformed independently of an attitude of the fuel cell 10.

Since the separation of the gas (in this embodiment, carbon dioxide (CO₂)) from the unused liquid fuel LP is performed on the anode electrode side of the electrolytic membrane 12a in the membrane-electrode assembly 12, the overall size of the fuel cell 10 can be made much smaller than that of the above described conventional fuel cell in which the separation of the gas from the unused liquid fuel is performed in the outside of the fuel cell, and a manufacturing cost of the fuel cell 10 of this embodiment can also be made low. Further, since the pressure of the liquid fuel LP in the liquid fuel supply path 20a on the anode electrode side of the electrolytic membrane 12a in the membrane-electrode assembly 12 is always increased by a predetermined value more than that of the gas (in this embodiment, carbon dioxide (CO₂)) in the minute pore member 26 which is the one end portion of the gas discharge path 20b connected to the liquid fuel supply path 20a on the anode electrode side of the electrolytic membrane 12a, the efficiency of the gas-fuel liquid separation is much improved and is further unaffected by the change of the attitude of the fuel cell 10 to a direction in which the gravity acts.

Incidentally, in this embodiment, the on-off valve 42 and pressurizing pump 44 of the liquid fuel supply path 20a opens and acts only for a predetermined time period at every predetermined time, respectively. Thereby, a fresh liquid fuel LP can be replenished from the liquid fuel tank 22 by an amount of the liquid fuel LP consumed on the anode electrode side of the electrolytic membrane 12a in the membrane-electrode assembly 12, for every predetermined time period.

That is, the on-off valve 42 and the pressurizing pump 44 are combined with the liquid fuel tank 22 as a liquid fuel supply source and configure a liquid fuel replenishing unit 46 which replenishes the fresh liquid fuel LP from the liquid fuel supply source such as the liquid fuel tank 22 to the liquid fuel supply path 20a.

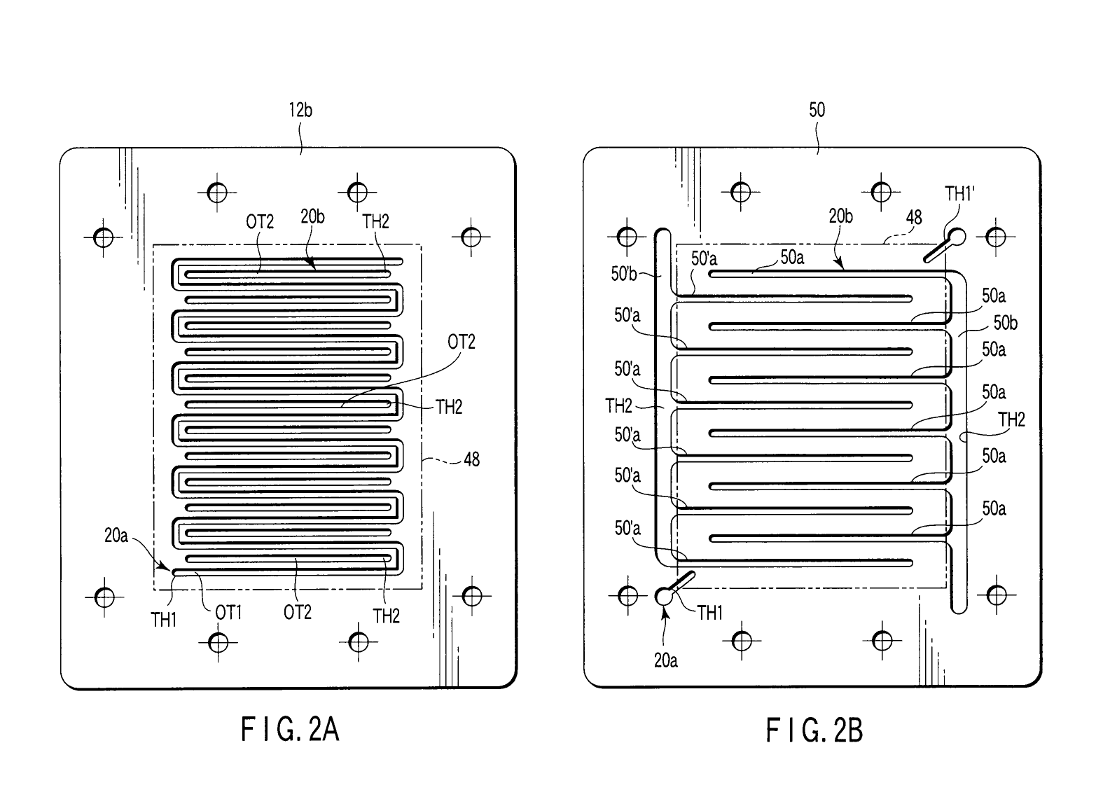

Next, with reference to FIGS. 2A to 4C, the stacking structure 20 used in the fuel cell 10 according to the first embodiment of the present invention and described above with reference to FIG. 1 will be explained in more detail.

As shown in FIG. 2A, an outlet port OT1 of the one through-hole TH1 of the liquid fuel supply path 20a in the inner surface of the anode electrode 12b facing the electrolytic membrane 12a has a cross-sectional area larger than that of the through-holes TH1 of the liquid fuel supply path 20a in the stacking member being farthest from the anode electrode 12b in the stacking structure 20. Outlet ports OT2 of the through-holes TH2 of the gas discharge path 20b in the inner surface of the anode electrode 12b also has a cross-sectional area larger than that of the through-holes TH2 of the gas discharge path 20b in the stacking member being farthest from the anode electrode 12b in the stacking structure 20.

These make it possible to diffuse the liquid fuel LP supplied into the anode chamber 16a (see FIG. 1) on the anode electrode side of the electrolytic membrane 12a in the membrane-electrode assembly 12 through the liquid fuel supply path 20a more evenly and more widely in the anode chamber 16a (see FIG. 1). Further, the gas discharge path 20b is allowed to discharge the gas generated from the liquid fuel LP in the anode chamber 16a evenly from a broader region in the anode chamber 16a.

Specifically, the outlet port OT1 of the one through-hole TH1 of the liquid fuel supply path 20a in the inner surface of the anode electrode 12b is configured by a long snaking slender hole. The long snaking slender hole snakes between near both right and left sides in a rectangular anode chamber opposite region 48 facing the anode chamber 16a (see FIG. 1) of the membrane-electrode assembly 12 on the inner surface at equal intervals from the vicinity of the lower side of the anode chamber opposite region 48 to the vicinity of the upper side thereof.

The gas discharge path 20b includes a plurality (twelve in the FIG. 2A) of through-holes TH2 in the anode electrode 12b, and each outlet port OT2 of the through-holes TH2 of the gas discharge path 20b in the inner surface of the anode electrode 12b has a slender shape extending straightly between adjacent two laterally and straightly extending parts of the outlet port OT1 of the through-hole TH1 of the liquid fuel supply path 20a in the inner surface along the adjacent two parts.

In this embodiment, the gas discharge path 20b includes a plurality (two in FIG. 2B) of through-holes TH2 in a first stacking member 50 stacked on an outer surface of the anode electrode 12b.

One of the two through-holes TH2 of the gas discharge path 20b in the first stacking member 50 (for example, the through-hole TH2 on the right side in FIG. 2B) includes a plurality of slender communicating portions 50a and one connecting portion 50b. The slender communicating portions 50a correspond to every other laterally and straightly extending slender through-holes TH2 of the gas discharge path 20b in the anode electrode 12b shown in FIG. 2A and extend laterally and straightly along the corresponding slender through-holes TH2 of the gas discharge path 20b in the anode electrode 12b and communicate with the corresponding slender through-holes TH2. The one connecting portion 50b connects one ends of the slender communicating portions 50a with each other.

The other of the two through-holes TH2 of the gas discharge path 20b in the first stacking member 50 (for example, the through-hole TH2 on the left side in FIG. 2B) includes a plurality of slender communicating portions 50′a and one connecting portion 50′b. The slender communicating portions 50′a correspond to the remaining ones of the laterally and straightly extending slender through-holes TH2 of the gas discharge path 20b in the anode electrode 12b and extend laterally and straightly along the corresponding slender through-holes TH2 of the gas discharge path 20b in the anode electrode 12b and communicate with the corresponding slender through-holes TH2. The one connecting portion 50′b connects the other ends of the slender communicating portions 50′a positioned opposite to the one ends of the slender communicating portions 50a in the one of the two through-holes (for example, the through-hole TH2 on the right side in FIG. 2B) with each other.

The through-hole TH1 of the liquid fuel supply path 20a in the first stacking member 50 communicates with an end portion (a left lower end portion in FIG. 2A) of the one through-hole TH1 of the liquid fuel supply path 20a in the anode electrode 12b. In the first stacking member 50, another through-hole TH1′ communicating with the other end portion (a right upper end portion in FIG. 2A) of the one through-hole TH1 of the liquid fuel supply path 20a in the anode electrode 12b is also formed.

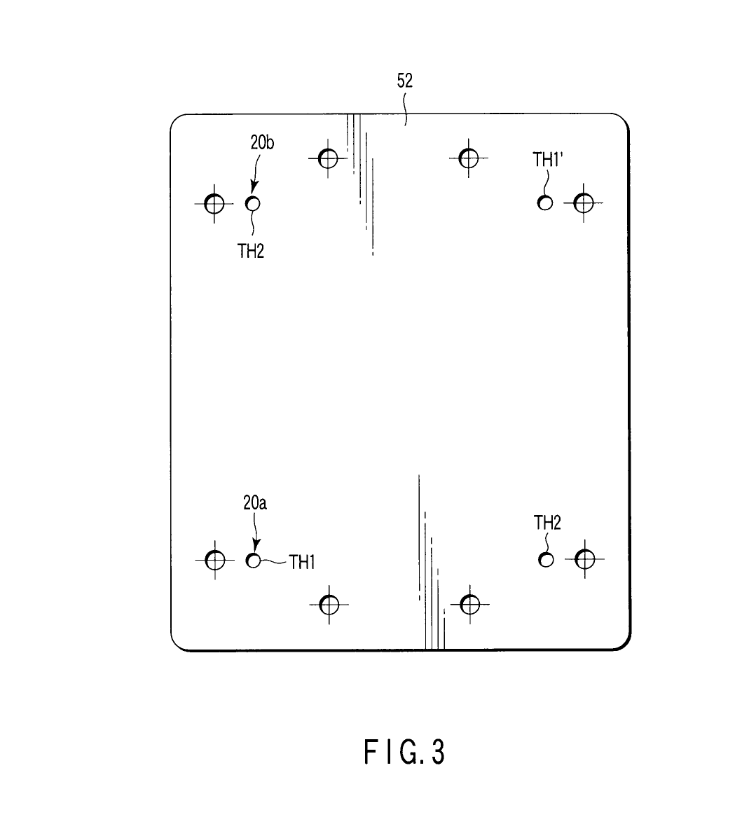

As shown in FIG. 3, the one through-hole TH1 of the liquid fuel supply path 20a in a second stacking member 52 stacked on an outer surface of the first stacking member 50 communicates with the one through-hole TH1 of the liquid fuel supply path 20a in the first stacking member 50.

The gas discharge path 20b includes two through-holes TH2 in the second stacking member 52, and the two through-holes TH2 of the gas discharge path 20b in the second stacking member 52 communicate with portions of the connecting portions 50b and 50′b of the two through-holes TH2 of the gas discharge path 20b in the first stacking body 50, respectively.

In the second stacking member 52, another through-hole TH1′ communicating with another through-hole TH1′ in the first stacking member 50 is further formed.

As shown in FIG. 1, the liquid fuel supply pipe 22a is connected to an outer end (namely, an inlet port) of the one through-hole TH1 of the liquid fuel supply path 20a in the outer surface (a back surface side of the paper showing in FIG. 3) of the second stacking member 52. As shown in FIG. 1, the one end portion of the liquid fuel return path 36 is connected to an outer end (namely, an outlet port) of another through-hole TH1′ in the outer surface (the back surface side of the paper showing in FIG. 3) of the second stacking member 52.

As shown in FIG. 1, a proximal end portion of the gas discharge pipe 28 is connected to outer ends (namely, outlet ports) of the two through-holes TH2 of the gas discharge path 20b in the outer surface (the back surface side of the paper showing in FIG. 3) of the second stacking member 52.

Incidentally, a plurality of circles attached with cross marks on each of the inner surfaces of the anode electrode 12b, first stacking member 50, and second stacking member 52 which are shown in FIGS. 2A, 2B, and 3, respectively, are positioning holes used to stack the anode electrode 12b, the first stacking member 50, and the second stacking member 52 on one another.

A plurality of stacking members including in the stacking structure 20 but excluding the anode electrode 12b, namely, the first and second stacking members 50 and 52 in this embodiment, is made from a material which is not corroded by the liquid fuel LP flowing through the through-holes TH1 and TH1′ included in the liquid fuel supply path 20a extending through the first and second stacking members 50 and 52 and by the gas flowing through the through-holes TH2 included in the gas discharge path 20b extending through the first and second stacking members 50 and 52, for example, a stainless steel (SUS), a titanium (Ti), or a carbon. And, the first and second stacking members 50 and 52 together with the anode electrode 12b are fixed to each other by a well-known sealing and fixing method such as a diffusion bonding in a state of being stacked in close contact with each other.

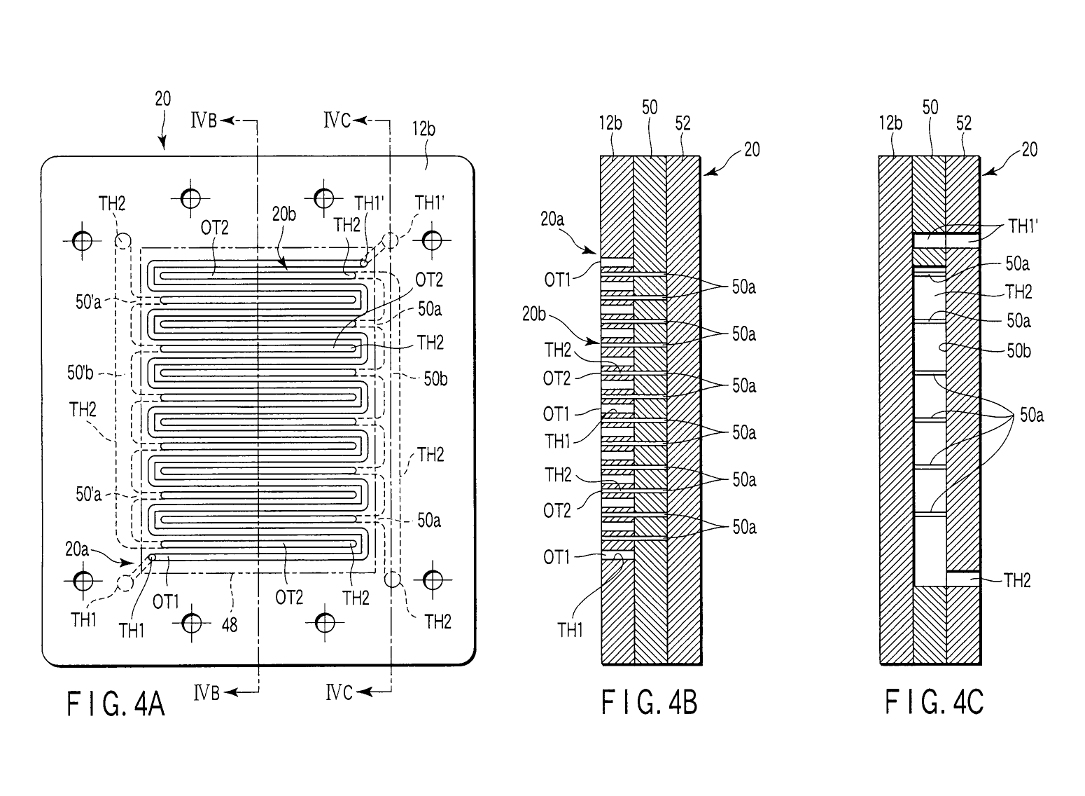

In FIG. 4A, the inner surface of the anode electrode 12b is shown in a state while the anode electrode 12b, the first stacking member 50, and the second stacking member 52 which are respectively shown in FIGS. 2A, 2B, and 3 are stacked on one another.

A longitudinal sectional view taken along a line IVB-IVB in FIG. 4A is schematically shown in FIG. 4B, and a longitudinal sectional view taken along a line IVC-IVC in FIG. 4A is schematically shown in FIG. 4C.

It can be understood from FIGS. 4A, 4B and 4C how the through-holes TH1 for the liquid fuel supply path 20a, the other through-holes TH1′ for the liquid fuel return path 36, and the through-holes TH2 for the gas discharge path 20b communicate with each other in the anode electrode 12b, first stacking member 50, and second stacking member 52 in the stacking structure 20.

### First Modification of the First Embodiment

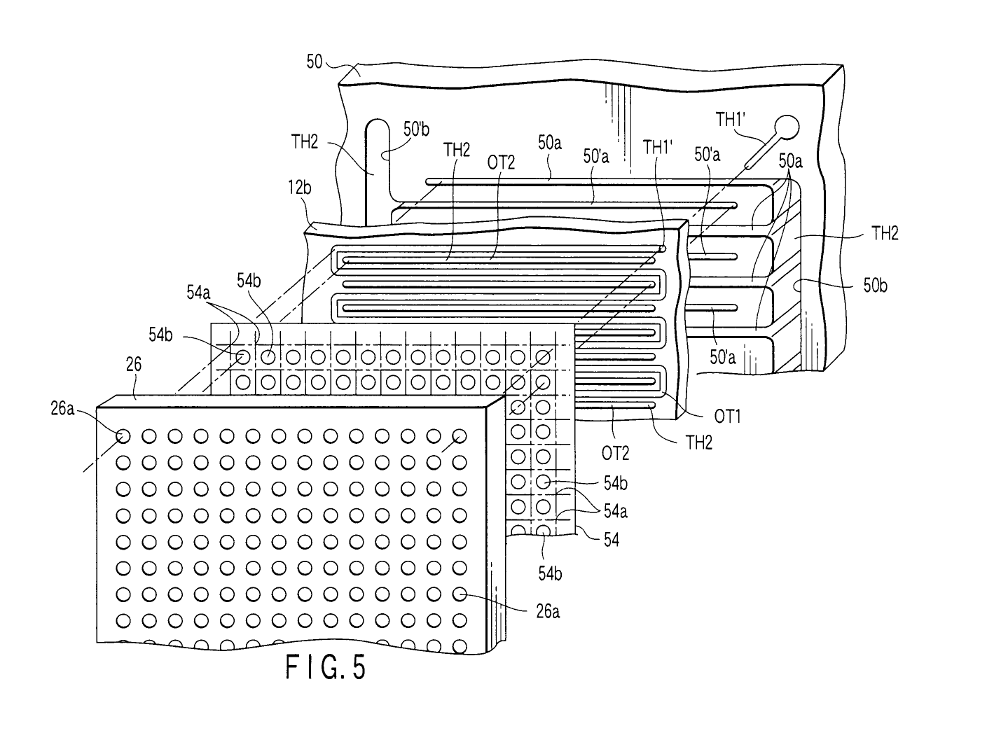

In this modification, as shown in FIG. 5, a through-hole member 54 is further provided in the membrane-electrode assembly 12. And, the through-hole member 54 is interposed between the anode electrode 12b and the minute pore member 26 of the gas-liquid separating structure 24. Through-hole member 54 is provided with a plurality of first through-holes 54a (in FIG. 5, shown by crosses of a plurality of rows and columns of dashed lines, for clarification in the figure) and a plurality of second through-holes 54b being independent from the first through-holes 54a. The first through-holes 54a correspond to the through-holes 26a of the minute pore member 26 of the gas-liquid separating structure 24, and the second through-holes 54b correspond to the outlet ports OT2 of the through-holes TH2 of the gas discharge path 20b in the inner surface of the anode electrode 12b.

The second through-holes 54b of the through-hole member 54 expand an opposite area of the outlet port OT2 of each through-hole TH2 of the gas discharge path 20b in the inner surface of the anode electrode 12b to the many minute pores between the through-holes 26a of the minute pore member 26 of the gas-liquid separating structure 24. As a result, it becomes easy for the gas generated in the liquid fuel LP in the through-holes 26a of the minute pore member 26 to be discharged from the outlet port OT2 of each through-hole TH2 of the gas discharge path 20b in the inner surface of the anode electrode 12b through the many minute pores between the through-holes 26a.

### Second Modification of the First Embodiment

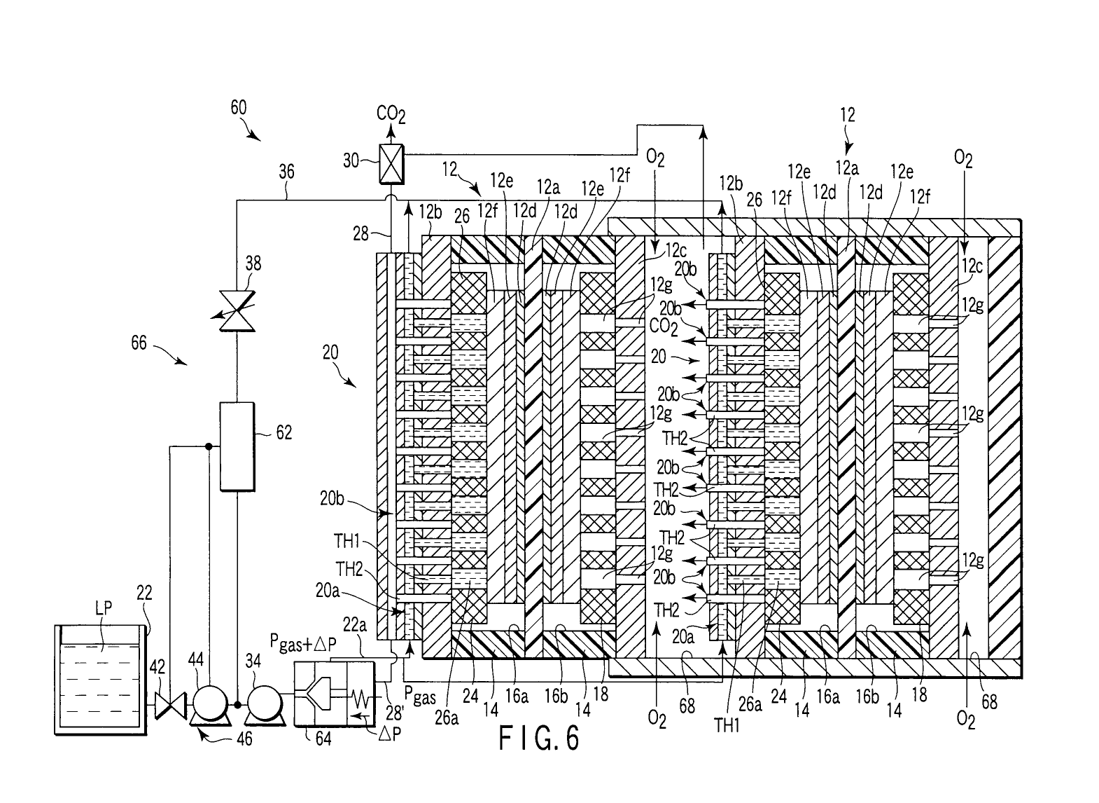

In FIG. 6, a longitudinal sectional view of a second modification of the fuel cell 10 according to the first embodiment of the present invention is schematically shown.

Most structural elements of a fuel cell 60 of this modification are the same as those of the fuel cell 10 of the first embodiment described above with reference to FIG. 1. Therefore, the structural elements of the fuel cell 60 corresponding to those of the fuel cell 10 are denoted by the same reference numerals as those designating the corresponding structural elements of the fuel cell 10, and detailed explanations on these structural elements will be omitted.

The fuel cell 60 is different from the fuel cell 10 shown in FIG. 1 in that the pressure gauge 40 is not interposed in the liquid fuel return path 36 but a liquid fuel concentration measuring unit 62 is interposed in the liquid fuel return path 36.

The fuel cell 60 is further different from the fuel cell 10 in the following matters.

A pressure adjusting unit 64 is interposed between the membrane-electrode assembly 12 and the liquid fuel pressurizing unit 34 in the liquid fuel supply pipe 22a of the liquid fuel supply path 20a. A branch 28′ from the gas discharge path 20b is connected to the pressure adjusting unit 64. The pressure adjusting unit 64 closes the liquid fuel supply pipe 22a with a pressure obtained by adding a predetermined pressure to the pressure of gas from the branch 28′, and blocks a flow of the liquid fuel LP into the liquid fuel supply pipe 22a.

The back-pressure valve 38 opens when the pressure of the liquid fuel LP in the liquid fuel return path 36, namely, in the liquid fuel supply path 20a on the anode electrode side of the electrolytic membrane 12a in the membrane-electrode assembly 12 is equal to or more than a predetermined pressure, and closes when the pressure thereof is less than the predetermined pressure.

Accordingly, in the fuel cell 60 according to the modification configured as described above, the pressure of the liquid fuel LP included in a portion of the liquid fuel supply path 20a from the liquid fuel pressurizing unit 34 to the anode electrode side of the electrolytic membrane 12a in the membrane-electrode assembly 12 and in a portion of the liquid fuel return path 36 from the anode electrode side of the electrolytic membrane 12a in the membrane-electrode assembly 12 to the back-pressure valve 38 is always kept at a predetermined value larger than the pressure of the gas in the gas discharge path 20b.

That is, the pressure of the liquid fuel LP in the liquid fuel supply path 20a on the anode electrode side of the electrolytic membrane 12a in the membrane-electrode assembly 12 is always increased by a predetermined value more than that of the gas (in this embodiment, carbon dioxide (CO₂)) in the minute pore member 26 which is the one end portion of the gas discharge path 20b connected to the liquid fuel supply path 20a on the anode electrode side of the electrolytic membrane 12a.

This means that a combination of the liquid fuel pressurizing unit 34 interposed in the liquid fuel supply path 20a, the liquid fuel return path 36 with the back-pressure valve 38, and the pressure adjusting unit 64 interposed in the liquid fuel supply path 20 and normally opened by a pressure obtained by adding the predetermined pressure to the pressure of the gas from the branch 28′ of the gas discharge path 20b configures a gas-liquid separation accelerating structure 66 in this modification.

Since it becomes easier for the gas (in this embodiment, carbon dioxide (CO₂)) generated as described above on the anode electrode side of the electrolytic membrane 12a in the membrane-electrode assembly 12 to be discharged into the minute pore member 26 which is the one end portion of the gas discharge path 20b connected to the liquid fuel supply path 20a on the anode electrode side of the electrolytic membrane 12a than to be included in the liquid fuel LP on the anode electrode side of the electrolytic membrane 12a in the membrane-electrode assembly 12, the discharge of the gas from the anode electrode side of the electrolytic membrane 12a is accelerated. This acceleration is preformed independently of an attitude of the fuel cell 60.

The liquid fuel concentration measuring unit 62 is configured to measure the concentration of the liquid fuel in the liquid fuel return path 36, and it opens the on-off valve 42 of the liquid fuel replenishing unit 46 and causes the pressurizing pump 44 to operate only for a predetermined time period when the measured concentration of liquid fuel lowers a predetermined value. Thereby, fresh liquid fuel LP can be replenished from the liquid fuel tank 22 through the pressure adjusting unit 64 by an amount of the liquid fuel LP consumed on the anode electrode side of the electrolytic membrane 12a in the membrane-electrode assembly 12 for every predetermined time period.

In the fuel cell 60 of this modification, a plurality (two in FIG. 6) of membrane-electrode assemblies 12 is arranged in series. A gas discharge path 20b of an additional membrane-electrode assembly 12 is connected to an external air introduction path 68 for the air supply paths 12g of the membrane-electrode assembly 12 adjacent to the additional membrane-electrode assembly 12, where the gas (in this embodiment, carbon dioxide (CO₂)) from the gas discharge path 20b of the additional membrane-electrode assembly 12 is discharged to the external air introducing path 68. The gas discharged to the external air introducing path 68 can be directly discharged from the external air introducing path 68 to the outside space, but it is preferable that the external air introducing path 68 is connected to the gas discharge pipe 28 so that the gas is discharged to outside space through the volatile organic compounds removing filter 30 of the gas discharge pipe 28.

Accordingly, the fuel cell 60 of this modification including the membrane-electrode assemblies 12 can operate similarly to the fuel cell 10 of the first embodiment shown in FIG. 1 and including one membrane-electrode assembly 12.

Incidentally, the liquid fuel concentration measuring unit 62 interposed in the liquid fuel return path 36 in the fuel cell 60 of this modification can be, of course, interposed in the liquid fuel return path 36 of the fuel cell 10 shown in FIG. 1 to control the operations of the on-off valve 42 and pressurizing pump 44 of the liquid fuel replenishing unit 46 as in the case of this modification.

### Second Embodiment

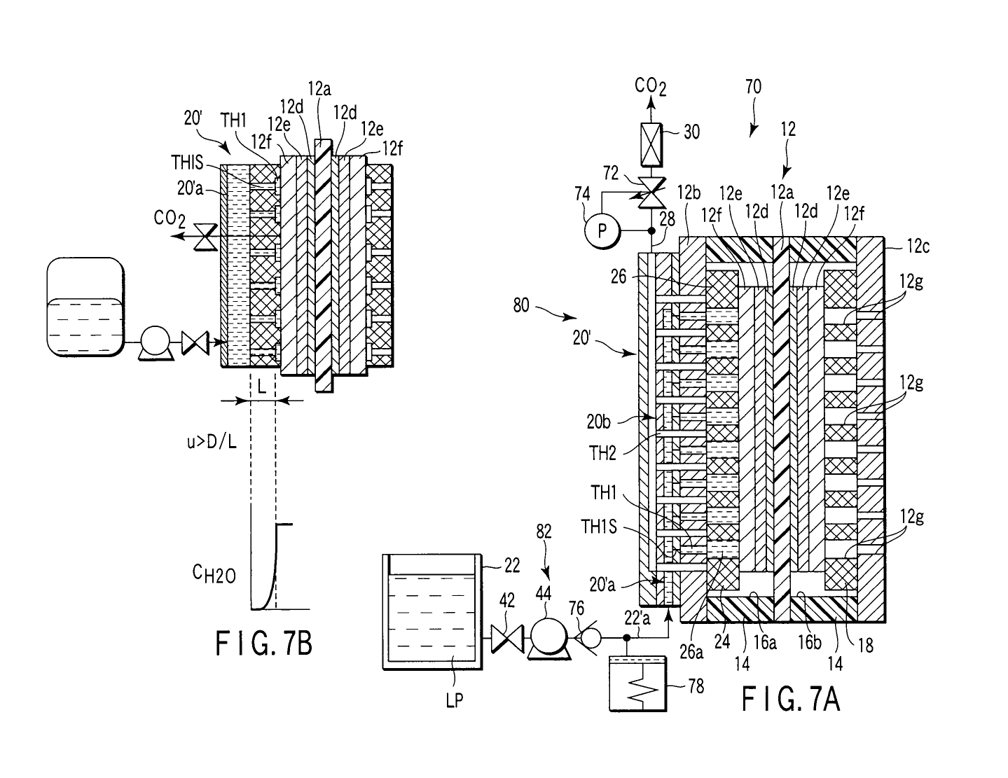

In FIG. 7A, a longitudinal sectional view of a fuel cell 70 according to a second embodiment of the present invention is schematically shown.

Most structural elements of the fuel cell 70 of this embodiment are the same as those of the fuel cell 10 of the first embodiment described above with reference to FIG. 1. Therefore, the structural elements of the fuel cell 70 corresponding to those of the fuel cell 10 are designated by the same reference numerals as those designating the corresponding structural elements of the fuel cell 10, and detailed explanations of these structural elements will be omitted.

The fuel cell 70 of this embodiment is different from the fuel cell 10 of the first embodiment in that the liquid fuel return path 36 with the back-pressure valve 38 and pressure gauge 40, which is used in the fuel cell 10, is not provided but a back-pressure valve 72 and a pressure gauge 74 are interposed in the gas discharge path 22b. The back-pressure valve 72 is configured to be opened when the pressure gauge 74 detects a pressure equal to or higher than a predetermined pressure and to be closed when the pressure gauge 74 detects a pressure lower than the predetermined pressure.

The fuel cell 70 of this embodiment is also different in the following point from the fuel cell 10 of the first embodiment.

The on-off valve 42, the pressurizing pump 44, the check valve 76, and a liquid fuel pressurizing unit 78 are interposed in a liquid fuel supply pipe 22′a between the liquid fuel tank 22 and the membrane-electrode assembly 12 and arranged in an above described order in a flowing direction of the liquid fuel LP in the liquid fuel supply pipe 22′a.

The liquid fuel pressurizing unit 78 can be a combination of a piston member provided in a liquid fuel reservoir interposed in the liquid fuel supply pipe 22′a and biasing means such as a compression spring interposed between the inner surface of the liquid fuel reservoir and the piston member.

A cross-sectional area of at least one through-hole TH1 of a liquid fuel supply path 20′a in at least one stacking member excepting a stacking member adjacent to the outer surface of the anode electrode 12b in a plurality of stacking members in the stacking structure 20 of the membrane-electrode assembly 12 is set to be smaller than that of at least one through-hole TH1 of the liquid fuel supply path 20a in a stacking member positioned closer to the anode electrode 12b than the above described at least one stacking member. The small cross-sectional area of the at least one stacking member causes the liquid fuel LP passing through the at least one small-sectioned through hole TH1 (hereinafter, indicated by reference numeral TH1S) toward the anode electrode side of the electrolytic membrane 12a in the membrane-electrode assembly 12 to generate a flow rate which prevents a backflow of the liquid fuel LP from the anode electrode side of the electrolytic membrane 12a in the membrane-electrode assembly 12.

Accordingly, that flow rate prevents water generated on the cathode electrode side of the electrolytic membrane 12a from penetrating toward the anode electrode side of the electrolytic membrane 12a and from diluting the liquid fuel on the anode electrode side, so that a power generation efficiency of the fuel cell 70 can be prevented from lowering.

In the fuel cell 70 according to the second embodiment and configured as described above, the back-pressure valve 72 is opened when the pressure of the gas (in this embodiment, carbon dioxide (CO₂)) in the minute pore member 26 which is the one end portion of the gas discharge path 20b connected to the liquid fuel supply path 20′a on the anode electrode side of the electrolytic membrane 12a becomes higher than a predetermined pressure of the liquid fuel LP included in a portion of the liquid fuel supply path 20′a from the liquid fuel pressurizing unit 78 to the anode electrode side of the electrolytic membrane 12a in the membrane-electrode assembly 12. That is, the pressure of the liquid fuel LP in the liquid fuel supply path 20′a on the anode electrode side of the electrolytic membrane 12a in the membrane-electrode assembly 12 is always made, by a predetermined value, higher than that of the gas (in this embodiment, carbon dioxide (CO₂)) in the minute pore member 26 which is the one end portion of the gas discharge path 20b which is connected to the liquid fuel supply path 20′a on the anode electrode side of the electrolytic membrane 12a.

This means that the liquid fuel pressurizing unit 78 interposed in the liquid fuel supply path 20′a and a combination of the back-pressure valve 72 and the pressure gauge 74 interposed in the gas discharge path 20b configure a gas-liquid separation accelerating structure 80 in this embodiment.

Since it becomes easier for the gas (in this embodiment, carbon dioxide (CO₂)) generated as described above on the anode electrode side of the electrolytic membrane 12a in the membrane-electrode assembly 12 to be discharged into the minute pore member 26 which is the one end portion of the gas discharge path 20b which is connected to the liquid fuel supply path 20′a on the anode electrode side of the electrolytic membrane 12a than to be included in the liquid fuel LP on the anode electrode side of the electrolytic membrane 12a in the membrane-electrode assembly 12, the discharge of the gas from the anode electrode side of the electrolytic membrane 12a is accelerated. This acceleration is preformed independently of an attitude of the fuel cell 70.

Incidentally, in this embodiment, the on-off valve 42 and pressurizing pump 44 of the liquid fuel supply path 20′a opens and operates only for a predetermined time period at every predetermined time, respectively. Thereby, fresh liquid fuel LP can be replenished from the liquid fuel tank 22 through the check valve 76 by an amount of the liquid fuel LP consumed on the anode electrode side of the electrolytic membrane 12a in the membrane-electrode assembly 12 for the every predetermined time period.

That is, the on-off valve 42, the pressurizing pump 44 and the check valve 76 are combined with a liquid fuel supply source such as the liquid fuel tank 22 and configure a liquid fuel replenishing unit 82 which replenishes fresh liquid fuel LP from the liquid fuel supply source such as the liquid fuel tank 22 to the liquid fuel supply path 20′a.

Next, with reference to FIG. 7B, in the liquid fuel supply path 20′a of the stacking structure 20′ provided with the stacking member including the through-hole TH1S having the small cross-sectional area and the stacking member being adjacent to the former stacking member on the electrolytic membrane side of the membrane-electrode assembly 12 and having the normal cross-sectional area, a design example about a dimension and an arrangement of the small-sectioned through-hole TH1S for generating a flow of the liquid fuel from the small-sectioned through-hole TH1S to the normal-sectioned through-hole TH1 in the liquid fuel supply path 20′a to prevent water from causing flow-back from the normal-sectioned through-hole TH1 to the small-sectioned through-hole TH1S will be explained.

The liquid fuel must be supplied by an amount obtained by adding a crossover amount to an amount consumed for an electric power generation on the anode electrode side of the electrolytic membrane 12a in the membrane-electrode assembly 12, from the small-sectioned through-hole TH1S to the normal-sectioned through-hole TH1 of the liquid fuel supply path 20′a of the adjacent stacking member.

The liquid fuel is 100 percent methanol,

i=150 mA/cm²,

q_{MeOH}_{_{—}}_{gen}=6.3×10⁻⁴ ccm/cm²

wherein “com” means a unit which is mL/minute at 25° C.

And, assuming that C.O. (crossover) is 20%,

q_{MeOH}_{_{—}}ₜₒₜₐₗ=7.9×10⁻⁴ ccm/cm².

Assuming that a diameter φ of the through-hole TH1S having the small cross-sectional area is 0.05 cm,

U_{MeOH}_{_{—}}ₜₒₜₐₗ=6.7×10⁻³ cm/s,

DH₂O=3×10⁻⁵ cm²/s. And, assuming that the length of the small-sectioned though hole TH1S is L=0.2 cm, D/L=1.5×10⁻⁴ cm/s.

Then, C/Co=exp(−u/D·L)=4.9×10⁻²⁰=0

That is, it can be understood in this case that, if small-sectioned through-holes TH1S each of which has a diameters of 50 μm are positioned at intervals of 1 cm, the liquid fuel flowed from the small-sectioned through-hole TH1S into the normal-sectioned through-hole TH1 in the liquid fuel supply path 20′a prevents water from flowing back from the normal-sectioned through-hole TH1 into the small-sectioned through-hole TH1A.

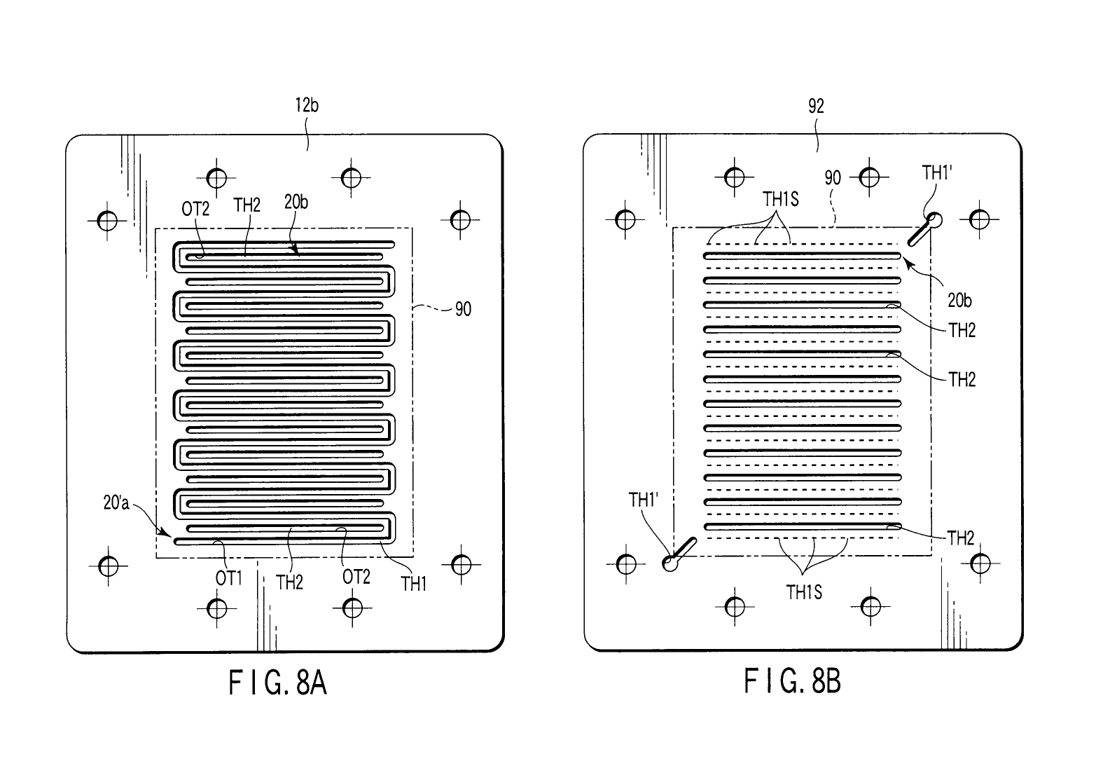

Next, with reference to FIGS. 8A to 11C, the stacking structure 20′ used in the fuel cell 70 according to the second embodiment of the present invention and described above with reference to FIG. 7A will be explained in more detail.

As shown in FIG. 8A, an outlet port OT1 of the at least one (one in FIG. 8A) through-hole TH1 of the liquid fuel supply path 20′a in the inner surface of the anode electrode 12b facing the electrolytic membrane 12a has a cross-sectional area larger than that of the at least one through-hole TH1 of the liquid fuel supply path 20′a in the stacking member located farthest from the anode electrode 12b in the stacking structure 20′. An outlet port OT2 of the at least one (plural number in this embodiment, and twelve in FIG. 8A) through-hole TH2 of the gas discharge path 20b in the inner surface of the anode electrode 12b facing the electrolytic membrane 12a also has a cross-sectional area larger than that of the at least one through-hole TH2 in the anode electrode 12b in the gas discharge path 20b in the stacking member located farthest from the anode electrode 12b in the stacking structure 20′.

This makes it possible to diffuse the liquid fuel LP supplied into the anode chamber 16a (see FIG. 7A) on the anode electrode side of the electrolytic membrane 12a in the membrane-electrode assembly 12 through the liquid fuel supply path 20′a more evenly and more widely in the anode chamber 16a. Further, the gas discharge path 20b can be allowed to discharge the gas generated from the liquid fuel LP in the anode chamber 16a on the anode electrode side of the electrolytic membrane 12a in the membrane-electrode assembly 12 evenly from a broader region in the anode chamber 16a.

Specifically, the liquid fuel supply path 20′a includes one through-hole TH1 in the anode electrode 12b, and the outlet port OT1 of the through-hole TH1 in the inner surface of the anode electrode 12b is configured by a long slender snaking hole. The long slender snaking hole snakes between near both right and left sides of a rectangular anode chamber opposite region 90 facing the anode chamber 16a (see FIG. 7) of the membrane-electrode assembly 12 on the inner surface at equal intervals from the vicinity of the lower side of the anode chamber opposite region 90 to the vicinity of the upper side thereof.

The gas discharge path 20b includes a plurality of through-holes TH2 in the anode electrode 12b, and each outlet port OT2 of the through-holes TH2 in the inner surface of the anode electrode 12b has a slender shape extending straightly between adjacent two laterally and straightly extending parts of the snaking outlet port OT1 of the through-hole TH1 of the liquid fuel supply path 20′a in the inner surface and along the adjacent two laterally and straightly extending parts.

As shown in FIG. 8B, the liquid fuel supply path 20′a in a stacking member 92 stacked on the outer surface of the anode electrode 12b and located firstly from the anode electrode 12b includes a plurality of through-holes TH1S each of which has a small cross-sectional area and which are arranged to face a plurality of positions in each laterally and straightly extending part of the slender snaking outlet port OT1 of the through-hole TH1 of the liquid fuel supply path 20′a in the anode electrode 12b.

The gas discharge path 20b in the first stacking member 92 includes a plurality of through-holes TH2 corresponding to and extending straightly along the through-holes TH2 of the gas discharge path 20b in the anode electrode 12b.

In the first stacking member 92, at least one through-hole TH1′ communicating with the slender snaking outlet port OT1 of the through-hole TH1 in the anode electrode 12b is further formed. In FIG. 8B, two through-holes TH1′ formed in the first stacking member 92 to communicate with both end portions of the slender snaking outlet port OT1 of the through-hole TH1 in the anode electrode 12b is shown.

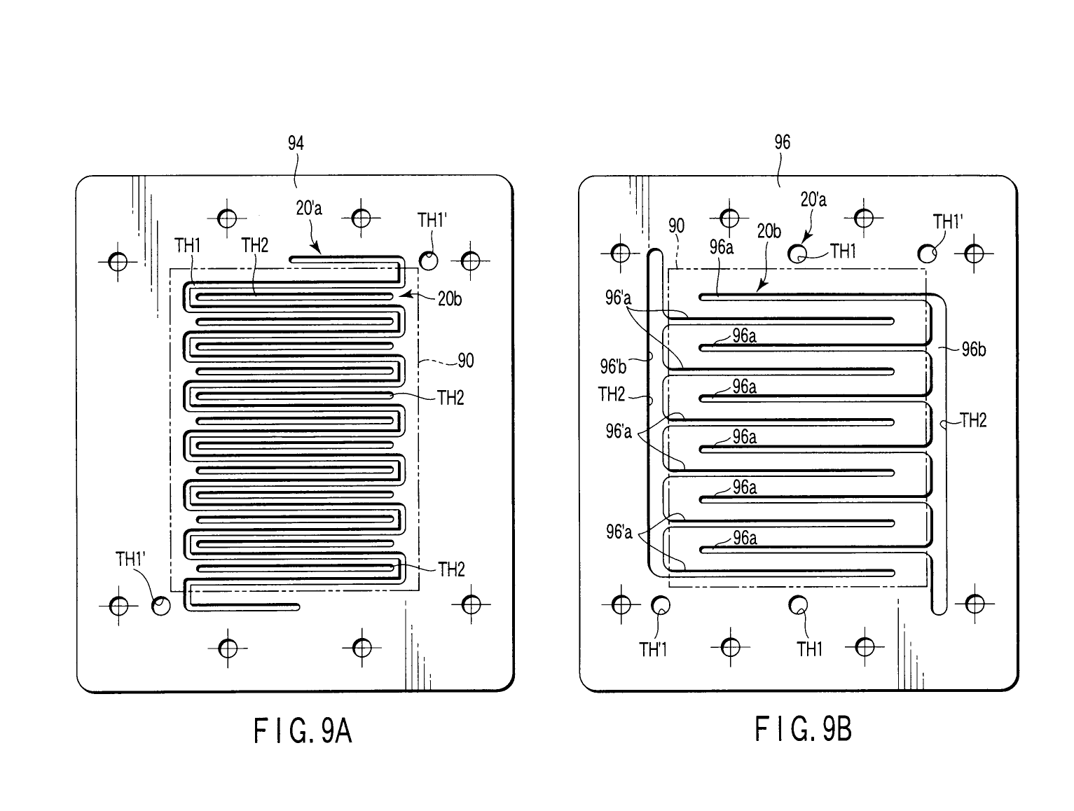

As shown in FIG. 9A, the liquid fuel supply path 20′a in a stacking member 94 stacked on the outer surface of the first stacking member 92 and located secondly from the anode electrode 12b includes one through-hole TH1 snaking at equal intervals along the slender snaking outlet port OT1 of the through-hole TH1 of the liquid fuel supply path 20′a in the anode electrode 12b.

In the second stacking member 94, the gas discharge path 20b includes a plurality of slender through-holes TH2 corresponding to and extending straightly along the laterally and straightly extending slender through-holes TH2 of the gas discharge path 20b in the first stacking member 92.

In the second stacking member 94, at least one (two in FIG. 9A) through-hole TH1′ communicating with the at least one (two in FIG. 8B) through-hole TH1′ in the first stacking member 92 is further formed.

In this embodiment, the gas discharge path 20b includes a plurality (two in FIG. 9B) of through-holes TH2 in a stacking member 96 stacked on the outer surface of the second stacking member 94 and located thirdly from the anode electrode 12b.

One of the two through-holes TH2 of the gas discharge path 20b in the third stacking member 96 (for example, the through-hole TH2 on the right side in FIG. 9B) includes a plurality of slender communicating portions 96a and one connecting portion 96b. The slender communicating portions 96a correspond to and extend straightly along every other laterally and straightly extending slender through-holes TH2 of the gas discharge path 20b in the second stacking member 94 shown in FIG. 9A. The slender communicating portions 96a communicate with the corresponding slender through-holes TH2 of the gas discharge path 20b in the second stacking member 94. And, the one connecting portion 96b connects one ends of the slender communicating portions 50a with each other.

The other of the two through-holes TH2 of the gas discharge path 20b in the third stacking member 96 (for example, the through-hole TH2 on the left side in FIG. 9B) includes a plurality of slender communicating portions 96′a and one connecting portion 96′b. The slender communicating portions 96′a correspond to and extend straightly along the remaining ones of the laterally and straightly extending slender through-holes TH2 of the gas discharge path 20b in the second stacking member 94. The slender communicating portions 96′a communicate with the corresponding slender through-holes TH2. The one connecting portion 96′b connects the other ends of the slender communicating portions 96′a with each other, the other ends being positioned opposite to the one ends of the slender communicating portions 96a of the one through-hole TH2.

In the third stacking member 96, at least one through-hole TH1 communicating with the slender snaking through-hole TH1 in the second stacking member 94 is further formed. In FIG. 9B, in the third stacking member 96, two through-holes TH1 communicating with both end portions of the slender snaking through-hole TH1 in the second stacking member 94 are shown.

In the third stacking member 96, another (two in FIG. 9A) through-hole TH1′ communicating with another (two in FIG. 9A) through-hole TH1′ in the second stacking member 94 is further formed.

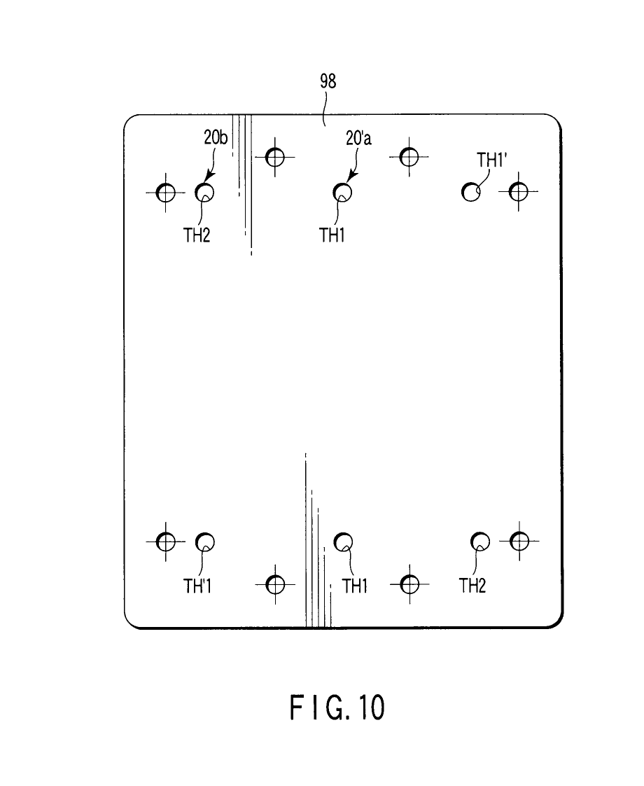

As shown in FIG. 10, at least one (two in FIG. 10) through-hole TH1 of the liquid fuel supply path 20′a in a stacking member 98 stacked on the outer surface of the third stacking member 96 and located fourthly from the anode electrode 12b communicates with the at least one (two in FIG. 9B) through-hole TH1 of the liquid fuel supply path 20′a in the third stacking member 96.

The gas discharge path 20b includes two through-holes TH2 in the fourth stacking member 98, and the two through-holes TH2 in the fourth stacking member 98 communicate with parts of the connecting portions 96b and 96′b of the two through-holes TH2 of the gas discharge path 20b in the third stacking member 96, respectively.

In the fourth stacking member 98, another (two in FIG. 10) through-hole TH1′ communicating with another (two in FIG. 9B) through-hole TH1′ in the third stacking member 96 is further formed.

In the stacking structure 20′, the fourth stacking member 98 is the stacking member located farthest from the anode electrode 12b.

As shown in FIG. 7A, the liquid fuel supply pipe 22′a is connected to an outer end (namely, inlet port) of the at least one (two in FIG. 10) through-hole TH1 of the liquid fuel supply path 20′a in the outer surface (back surface side of the paper showing FIG. 10) of the fourth stacking member 98. An outer end (namely, outlet port) of the at least one (two in FIG. 10) through-hole TH1′ in the outer surface of the fourth stacking member 98 is closed or connected to the liquid fuel supply pipe 22′a between the check valve 76 and the liquid fuel supply unit 78 through a liquid fuel return path (not shown) similar to the liquid fuel return path 36 having the back pressure valve 38 and pressure gauge 40 shown in FIG. 1.

As shown in FIG. 7A, a proximal end portion of the gas discharge pipe 28 is connected to outer ends (namely, outlet ports) of the two through-holes TH2 of the gas discharge path 20b in the outer surface (back surface side of the paper showing FIG. 10) of the fourth stacking member 98.

Incidentally, a plurality of circles attached with cross marks on each of the inner surfaces of the anode electrode 12b and first to fourth stacking members 92, 94, 96, and 98 shown in FIGS. 8A, 8B, 9A, 9B, and 10 is positioning holes used when the anode electrode 12b and first to fourth stacking members 92, 94, 96, and 98 are stacked on one another.

The plurality of stacking members excepting the anode electrode 12b and included in the stacking structure 20′, the first to fourth stacking members 92, 94, 96, and 98 in this embodiment, are formed from a material which is not corroded by the liquid fuel LP which flows through the at least one through-hole TH1 and at least one through-hole TH1′ which are included in the liquid fuel supply path 20′a penetrating the first to fourth stacking members 92, 94, 96, and 98 and by the gas which flows through the at least one through-hole TH2 included in the gas discharge path 20b penetrating the first to fourth stacking members 92, 94, 96, and 98. Such a material for the stacking members is, for example, stainless steel (SUS), titanium (Ti), or carbon. And, the first to fourth stacking members 92, 94, 96, and 98 together with the anode electrode 12b are fixed to each other by a well-known sealing and fixing method such as a diffusion bonding in a state of being stacked in close contact with each other.

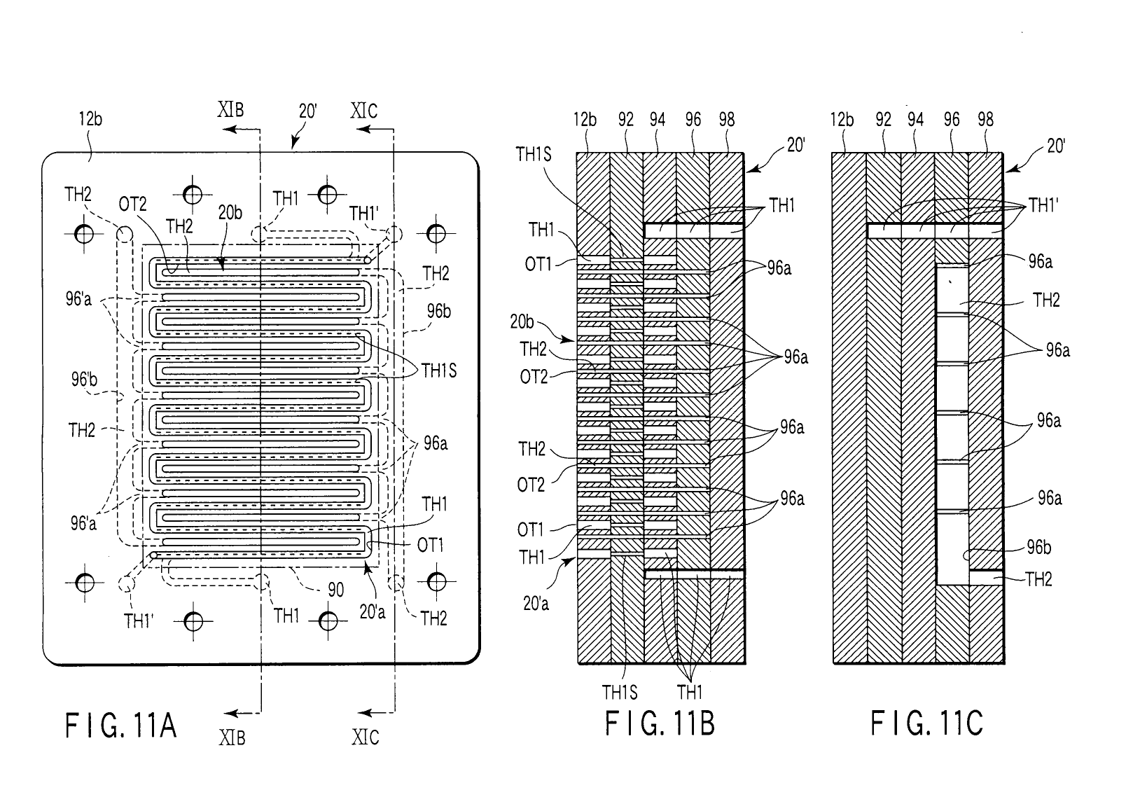

In FIG. 11A, an inner surface of the anode electrode 12b is shown in a state while the first to fourth stacking members 92, 94, 96, and 98 shown in FIGS. 8A, 8B, 9A, 9B, and 10 are stacked on one another on the outer surface of the anode electrode 12b.

A longitudinal sectional view taken along a line XIB-XIB in FIG. 11A is schematically shown in FIG. 11B, and a longitudinal sectional view taken along a line XIC-XIC in FIG. 11A is schematically shown in FIG. 11C.

It can be understood from FIGS. 11A, 11B and 11C how the at least one through-hole TH1, small-sectioned through-holes TH1S, at least another one through-hole TH1′ for the liquid fuel supply path 20′a, and the at least one through-hole TH2 for the gas discharge path 20b communicate with one another in the anode electrode 12b and first to fourth stacking members 92, 94, 96, and 98 in the stacking structure 20′.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A fuel cell comprising:
a membrane-electrode assembly including an electrolytic membrane and anode and cathode electrodes disposed on both sides of the membrane, the anode electrode having an outer surface and an inner surface opposing to the outer surface and facing the membrane;
a liquid fuel supply unit configured to provide a liquid fuel supply path supplying liquid fuel to the anode electrode side of the membrane in the assembly;
an air supply unit configured to provide an air supply path supplying air to the cathode electrode side of the membrane in the assembly;
a gas discharge unit configured to provide a gas discharge path discharging gas from the anode electrode side of the membrane in the assembly; and
a plurality of stacking members stacked in a state of sealing each other on the outer surface of the anode electrode,
the anode electrode and the stacking members configuring a stacking structure,
the liquid fuel supply path including at least one through-hole passing through the stacking structure, and
the gas discharge path including at least one through-hole passing through the stacking structure independently of the at least one through-hole of the liquid fuel supply path.

2. The fuel cell according to claim 1, wherein
the at least one through-hole of the liquid fuel supply path has an outlet port in the inner surface of the anode electrode, the outlet port having a cross-sectional area larger than a cross-sectional area of the at least one through-hole of the liquid fuel supply path in the stacking member located farthest from the anode electrode in the stacking members, and
the at least one through-hole of the gas discharge path has an outlet port in the inner surface of the anode electrode, the outlet port having a cross-sectional area larger than a cross-sectional area of the at least one through-hole of the gas discharge path in the stacking member located farthest from the anode electrode in the stacking members.

3. The fuel cell according to claim 2, further comprising
a gas-liquid separating structure interposed between the membrane and the anode electrode in the assembly and configured to separate the liquid fuel supplied to the anode electrode side of the membrane in the assembly through the liquid fuel supply path and gas generated from the liquid fuel on the anode electrode side of the membrane from each other and to lead the separated gas to the gas discharge path.

4. The fuel cell according to claim 3, wherein
the separating structure includes a minute pore member including a plurality of through-holes extending toward the membrane from a position corresponding to the outlet port of the at least one through-hole of the liquid fuel supply path in the inner surface of the anode electrode and many minute pores, each minute pore being finer than each through-holes, and the minute pores communicating with the through-holes of the minute pore member and the outlet port of the at least one through-hole of the gas discharge path in the inner surface of the anode electrode, and
the minute pore member has at least either one of hydrophobic nature and repellency.

5. The fuel cell according to claim 4, further comprising
a through-hole member interposed between the anode electrode and the separating structure in the assembly, the through-hole member including a plurality of first through-holes corresponding to the through-holes of the separating structure and a plurality of second through-holes being independent of the first through-holes and corresponding to the outlet port of the at least one through-hole of the gas discharge path in the inner surface of the anode electrode.

6. The fuel cell according to claim 2, wherein
the outlet port of the at least one through-hole of the liquid fuel supply path in the inner surface of the anode electrode snakes at equal intervals along the inner surface,
the gas discharge path in the anode electrode includes a plurality of through-holes having outlet ports in the inner surface of the anode electrode, and
each outlet port of the through-holes of the gas discharge path in the inner surface of the anode electrode extends between two adjacent parts of the snaking outlet port of the at least one through-hole of the liquid fuel supply path in the inner surface of the anode electrode along the two adjacent parts.

7. The fuel cell according to claim 6, wherein
the gas discharge path in the stacking member stacked firstly on the outer surface of the anode electrode includes two through-holes,
one of the two through-holes of the gas discharge path in the first stacking member includes a plurality of slender communicating portions, which correspond to every other slender through-holes of the gas discharge path in the anode electrode and which extend along the corresponding slender through-holes of the gas discharge path in the anode electrode and which communicate with the corresponding slender through-holes, and a connecting portion connecting one ends of the slender communicating portions with each other,
the other of the two through-holes of the gas discharge path in the first stacking member includes a plurality of slender communicating portions, which correspond to the remaining ones of the slender through-holes of the gas discharge path in the anode electrode and which extend along the corresponding slender through-holes of the gas discharge path in the anode electrode and which communicate with the corresponding slender through-holes, and a connecting portion connecting the other ends of the slender communicating portions with each other, the other ends of the slender communicating portions being positioned opposite to the one ends of the slender communicating portions of the one of the two through-holes;
the at least one through-hole of the liquid fuel supply path in the first stacking member communicates with the at least one through-hole of the liquid fuel supply path in the anode electrode;
the at least one through-hole of the liquid fuel supply path in the stacking member positioned secondly from the anode electrode and stacked on an outer surface of the first stacking member, the outer surface being positioned opposite to the outer surface of the anode electrode, communicates with the at least one through-hole of the liquid fuel supply path in the first stacking member; and
the gas discharge path in the second stacking member includes two through-holes, and each of the two through-holes of the gas discharge path in the second stacking member communicate with a part of each of the connecting portions of the two through-holes of the gas discharge path in the first stacking member.

8. The fuel cell according to claim 1, wherein
the liquid fuel supply unit includes a liquid fuel replenishing unit configured to replenish the same amount of liquid fuel as that used on the anode electrode side of the membrane in the assembly to the liquid fuel supply path.

9. The fuel cell according to claim 1, further comprising
a liquid fuel return unit configured to provide a liquid fuel return path including one end portion, which is connected to the at least one through-hole of the liquid fuel supply path in the stacking member located outermost in the stacking members, and the other end portion, which is connected to the liquid fuel supply path in an outside of the assembly and stacking members, the return path returning liquid fuel unreacted on the anode electrode side of the membrane in the assembly to the liquid fuel supply path.

10. The fuel cell according to claim 9, wherein
the return unit includes a liquid fuel concentration measuring unit configured to measure a concentration of the liquid fuel in the return path, and
the liquid fuel supply unit includes a liquid fuel replenishing unit configured to replenish fresh liquid fuel to the liquid fuel supply path when the concentration of the liquid fuel measured by the measuring unit becomes lower than a predetermined value.

11. The fuel cell according to claim 1, wherein
the liquid fuel includes hydrocarbon or a mixture of hydrocarbon and water.

12. The fuel cell according to claim 11, wherein
the hydrocarbon includes methanol.

13. The fuel cell according to claim 2, wherein
a cross-sectional area of the at least one through-hole of the liquid fuel supply path in at least one stacking member excepting a stacking member stacked on the outer surface of the anode electrode is set to be smaller than that of the at least one through-hole of the liquid fuel supply path in a stacking member positioned closer to the anode electrode than the at least one stacking member, and
the small cross-sectional area of the at least one through-hole causes the liquid fuel passing through the at least one through-hole with the small cross-sectional area toward the anode electrode side of the membrane in the assembly to generate a flow rate preventing backflow of the liquid fuel from the anode electrode side of the membrane in the assembly.

14. The fuel cell according to claim 13, wherein
the at least one through-hole of the liquid fuel supply path in the anode electrode snakes at equal intervals along the inner surface of the anode electrode,
the gas discharge path in the anode electrode includes a plurality of through-holes having outlet ports in the inner surface of the anode electrode, and
each outlet port of the through holes of the gas discharge path in the inner surface of the anode electrode extends between two adjacent parts of the snaking outlet port of the at least one through-hole of the liquid fuel supply path in the inner surface of the anode electrode along the two adjacent parts.

15. The fuel cell according to claim 14, wherein
the liquid fuel supply path in the stacking member stacked firstly on the outer surface of the anode electrode includes a plurality of through-holes each having a small cross-sectional area, at a plurality of positions along a longitudinal direction of each of the two adjacent parts of the snaking outlet port of the at least one through-hole of the liquid fuel supply path in the anode electrode, and
the gas discharge path in the first stacking member includes a plurality of through-holes corresponding to the through-holes of the gas discharge path in the anode electrode and extending along the corresponding through-holes of the gas discharge path in the anode electrode.

16. The fuel cell according to claim 15, wherein
the liquid fuel supply path in the stacking member located secondly from the anode electrode and stacked on an outer surface of the first stacking member, the outer surface opposing to the outer surface of the anode electrode, includes at least one through-hole snaking at equal intervals along a longitudinal direction of each of two adjacent parts of the at least one snaking through-hole of the liquid fuel supply path in the anode electrode, and
the gas discharge path in the second stacking member includes a plurality of through-holes corresponding to the through-holes of the gas discharge path in the first stacking member and extending along the corresponding through-holes of the gas discharge path in the first stacking member.

17. The fuel cell according to claim 16, wherein
the gas discharge path in the stacking member located thirdly from the anode electrode and stacked on an outer surface of the second stacking member, the outer surface opposing to the outer surface of the first stacking member, includes two through-holes,
one of the two through-holes of the gas discharge path in the third stacking member includes a plurality of slender communicating portions, which correspond to every other slender through-holes of the gas discharge path in the second stacking member and which extend along the corresponding slender through-holes of the gas discharge path in the second stacking member and which communicate with the corresponding slender through-holes, and a connecting portion connecting one ends of the slender communicating portions with each other,
the other of the two through-holes of the gas discharge path in the third stacking member includes a plurality of slender communicating portions, which correspond to the remaining ones of the slender through-holes of the gas discharge path in the second stacking member and which extend along the corresponding slender through-holes of the gas discharge path in the second stacking member and which communicate with the corresponding slender through-holes, and a connecting portion connecting the other ends of the slender communicating portions with each other, the other ends of the slender communicating portions being positioned opposite to the one ends of the slender communicating portions of the one of the two through-holes;
the at least one through-hole of the liquid fuel supply path in the stacking member located fourthly from the anode electrode and stacked on an outer surface of the third stacking member, the outer surface opposing to the outer surface of the second stacking member, includes two through-holes; and
the gas discharge path in the fourth stacking member includes two through-holes, and each of the two through-holes of the gas discharge path in the fourth stacking member communicate with a part of each of the connecting portions of the two through-holes of the gas discharge path in the third stacking member.
